(19) United States
(12) Patent Application Publication
(10) Pub. No.: US 2021/0348428 A1
(43) Pub. Date: Nov. 11, 2021

(54) SECURITY ALARM AND ALERT SYSTEM FOR SLIDING WINDOWS AND DOORS

(71) Applicant: Latrice Bonner, Lawrenceville, GA (US)

(72) Inventor: Latrice Bonner, Lawrenceville, GA (US)

(21) Appl. No.: 17/244,496

(22) Filed: Apr. 29, 2021

Related U.S. Application Data
(62) Division of application No. 15/821,437, filed on Nov. 22, 2017, now abandoned.

(51) Int. Cl. E05C 19/00; G08B 29/18; E05B 45/06; G08B 25/10; G08B 13/196; G08B 13/08

(52) U.S. Cl. CPC E05C 19/003; G08B 29/181; G08B 13/08; G08B 25/10; G08B 13/19697; E05B 45/06

(57) ABSTRACT

A method and system of distributing and selling beauty care products using vending devices.

### CROSS-REFERENCE TO RELATED APPLICATION(S)

This application claims priority to U.S. Provisional Application Nos. 62/448,746 filed on Jan. 20, 2017, and entitled “Security Alarm and Alert System for Sliding Windows and Doors” and 62/448,702 filed on Jan. 20, 2017, and entitled “Portable Solar Power Assembly for Low Power Devices,” which are both incorporated herein by reference in their entirety.

### BACKGROUND

Today it is a common practice for pet owners to configure a sliding door or window of a home with an insert having a pet door or dog door to allow pets a small passage to enter and exit the home. Unfortunately, when using one of these inserts, the sliding door or window must remain in an open and unlocked position as the insert is placed between the door and the door frame preventing the locking mechanism from engaging. In some situations, a pet owner may place a door jamb or length of wood or metal within the sliding door track. However, the length of wood or metal must first be cut to size as the length of wood or metal required varies based on the size of the insert and the distance or gap between the frame and the sliding door itself. Additionally, these conventional door jams are easy to breach and are incompatible with home security systems. Thus, the conventional door jams do not provide any alert to the user or a security service once a home invasion has occurred.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment including a sliding door with a security system installed prior to a home invasion according to some implementations.

FIG. 2 illustrates the example environment of FIG. 1 including a sliding door with a security system installed during a home invasion according to some implementations.

FIG. 3 illustrates an example top view of the security door jamb in a contracted position, a partially extended position, and an extended position according to some implementations.

FIG. 4 illustrates an example perspective view of the security door jamb according to some implementations.

FIG. 5 illustrates an example side view of the security door jamb according to some implementations.

FIG. 6 illustrates another example top view of the security door jamb according to some implementations.

FIG. 7 illustrates an example top view of the portable power assembly according to some implementations.

FIG. 8 illustrates an example top view of the portable power assembly of FIG. 7 having the cover of the housing removed according to some implementations.

FIG. 9 illustrates an example side view of the portable power assembly of FIG. 7 removed according to some implementations.

FIG. 10 illustrates an example perspective view of the portable power assembly of FIG. 7 having the cover of the housing removed according to some implementations.

FIG. 11 illustrates example components of the security door jamb according to some implementations.

FIG. 12 illustrates example components of the portable power assembly according to some implementations.

FIG. 13 is an example flow diagram showing an illustrative process associated with detecting a home invasion according to some implementations.

FIG. 14 is an example flow diagram showing an illustrative process associated with detecting tampering with a portable power assembly connection to a security door jamb according to some implementations.

### DETAILED DESCRIPTION

This disclosure includes systems and implementations for securing sliding doors and windows from invasion. For example, the system discussed herein may include a security system used to secure a sliding door or window in an open position. For instance, many pet owners configure a sliding door or window of the owner's home with an insert having a pet door or dog door to allow the owner's pets the ability to enter and exit the home without assistance from the pet owner. Unfortunately, when one of these inserts is installed in a sliding door or window, the sliding door or window remains in an open and unlocked position, as the insert is placed between the door and the door frame preventing the locking mechanism of the door or window from engaging. Conventionally, a pet owner may place a door jamb (e.g., a length of wood or metal) within the sliding door track. However, the length of wood or metal varies based on the size of the insert and the distance or gap between the frame and the sliding door itself requiring the pet owner to cut the wood or metal to size before use. In some case, the pet owner may lack the equipment or expertise to cut metal and the wood door jams are often easy to breach. Further, conventional door jams are often incompatible with home security systems that alert the homeowner or a security service to a home breach, as the systems often require the door or window to be locked. Thus, the system discussed herein includes a security door jamb having a variable length that may be sized to fit between the gap in the open door and the door frame caused by the pet door insert. For instance, the security door jamb may be equipped with a configurable locking screw mechanism that allows the user to increase or decrease the length of the security door jamb between four feet and one foot in length. In another instance, the length of the security door jamb may vary between two feet and one foot. In some examples, the security door jamb may extend as far as 6, 8 or 10 feet in length and be compressed to as small as six inches or one foot in length.

In some implementations, the security door jamb may be configured to be placed within an open sliding door or window, such that the security door jamb is located at a distance from the ground or other horizontal surface, such that the security door jamb may vibrate, drop, fall, or otherwise be disturbed in the event that an individual attempts to open the sliding door or window. In some cases, the security door jamb may be equipped with measurements devices or components to determine orientation data or position data of the security door jamb. For instance, the security door jamb may be equipped with one or more internal measurement units (IMU), accelerometers, gyroscopes, barometric pressure sensors, magnetometers, or a combination thereof, capable of capturing orientation data of the door jamb, such as acceleration data, momentum data, position data, etc. In one particular example, the IMU may include three accelerometers placed orthogonal to each other, three rate gyroscopes placed orthogonal to each other, three magnetometers placed orthogonal to each other, and a barometric pressure sensor.

In some cases, the security door jamb system may be configured to detect a home invasion based on a disturbance or movement of the door jamb that exceeds one or more thresholds. For instance, the security door jamb may be equipped with one or more processors, such as at least one or more access components, control logic circuits, central processing units, or processors, as well as one or more computer-readable media to perform operations associated with determining if the security door jamb has been disturbed based at least in part on the orientation data collected by the measurement devices (e.g., the IMU units).

In some cases, the security door jamb may be configured to emit an audible alarm in response to detecting a disturbance exceeding the one or more thresholds. In some cases, the audible alarm may be programmable by the homeowner, to emit a custom warning or alarm The security door jamb may be equipped with one or more communication interfaces to send an alert to the homeowner that the sliding door or window has been breached. In some instances, the security door jamb may also include one or more image components to capture image data associated with the sliding door or window. In some situations, the security door jamb may activate the image components and store the captured image data upon the detection of the disturbance. In one particular example, the security door jamb may stream or send the image data to a device associated with the homeowner in conjunction with the alert.

In some implementations, the security door jamb may also notify a security service or emergency responder via the communication interface that the door or window has been breached. In some cases, the security door jamb may provide the notification to the security service or emergency responder if a security code is not entered within a predefined period of time following the activation of the alarm or detecting the disturbance of the security door jamb. Thus, the homeowner may avoid contacting security service or emergency responders in the case of an inadvertent disturbance of the security door jamb.

In some cases, the security door jamb and/or the door or window that the security door jamb is being used to secure may be at a location distant from a power source. Thus, in some cases, the security door jamb may be equipped with an internal power source or supply. In some cases, the power source or supply may be rechargeable. However, in some instances, such as when the homeowner is on vacation, the power source or supply may be insufficient for the period of time associated with the continued use of the security door jamb. In these instances, the security door jamb may be coupled to a portable power assembly.

The portable power assembly may include a backup power source or supply that may be configured to trickle charge the power source or supply of the security door jamb to extend the overall life of the security door jamb. In some cases, the portable power assembly may also include a solar power assembly to provide further extensions to the internal power supply and/or the power source or supply of the security door jamb. In some instances, the battery management circuit of the power assembly or a shared circuit between the power assembly and the door jamb may be configured such that the power signal or load is received or pulled directly from the solar panel or array prior to draining the power supply in the power assembly. Thus, the primary power source is the solar panel or array and the power supply of the power assembly may act as a backup when the supplied voltage from the solar panel or array is below a predefined threshold, such as a load requirement associated with the security door jamb.

In some cases, the power assembly may be equipped with one or more communication interfaces for providing power status data to a homeowner or other security service. For instance, the power assembly may provide alerts to the homeowner or security service that the power level associated with the power source or supply of the power assembly has fallen below one or more predefined thresholds. In some cases, the power supply dropping below one or more of the predefined thresholds may indicate that the solar panel or array is malfunctioning or blocked and that the system requires maintenance. Thus, the power assembly may alert the security service to send a maintenance repair or employee to check on the power assembly.

In some cases, the power assembly or the security door jamb may be configured to detect if the power assembly is released or decoupled from the security door jamb, and in response, to emit the alarm, alert the homeowner, and/or notify the security service or emergency responders. For instance, the security door jamb may include a pressure sensor within the female connector that receives a cord to connect the power assembly to the security door jamb and the security door jamb may be configured to emit the alarm, alert the homeowner, and/or notify the security service or emergency responders if the pressure sensor detects a release of the of the cord without receiving a predefined entry code prior thereto. In other cases, the security door jamb may detect tampering if the security door jamb has not received a recharge signal or power signal over a predefined period of time.

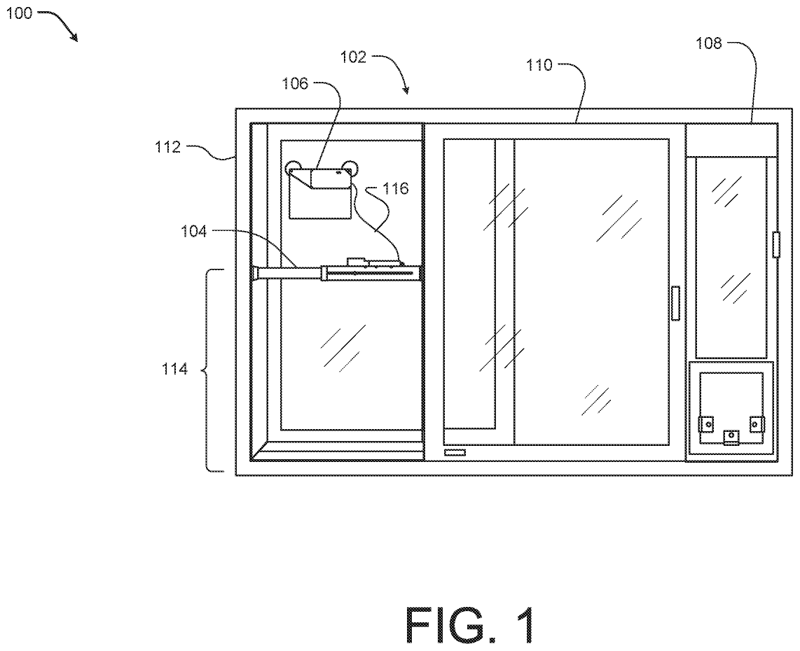

FIG. 1 illustrates an example environment 100 including a sliding door 102 with a security system, including a security door jamb 104 and a power assembly 106, installed prior to a home invasion according to some implementations. As illustrated, a pet door or pet door insert 108 has been installed within the opening of the sliding door 102 preventing the sliding door 102 from being fully closed and/or locked against a home invasion in a conventional manner (e.g., the lock and bolt). Additionally, because the sliding door 102 is in a partially open or open position, the alarm or whole home security system may be disabled with respect to the sliding door 102 preventing security personnel from being notified in the case of a home invasion.

Instead, the security door jamb 104 may be introduced into the sliding door 102 between the movable door 110 and the frame 112 of the sliding door 102. However, unlike conventional door jambs formed from wood or metal lengths, the security door jamb 104 may include two portions configured to slide or extend one within the other and to lock in various sized positions. Thus, the security door jamb 104 may be configured to fit various sized sliding doors 102 or windows without any manual cutting or permanent alterations to the door jamb 104.

As discussed above, the security door jamb 104 may be introduced into the sliding door 102 between the movable door 110 and the frame 112 of the sliding door 102. However, unlike conventional door jambs formed from wood or metal lengths, the security door jamb 104 may be situated at a position off of or above the ground, generally indicated by 114. In this example, the security door jamb 104 may be equipped with one or more measurement devices, such as IMUs, accelerometers, gyroscopes, barometric pressure sensors, magnetometers, or a combination thereof. Thus, the security door jamb 104 may be configured to detect a home invasion based on a disturbance or movement of the security door jamb 104 that exceeds one or more thresholds. For instance, the security door jamb 104 may be configured to detect movement representative of a fall from the data collected by the measurement units. For example, if a home invader opened the movable door 110 of the sliding door 102, the security door jamb 104 would either first need to be displaced for the movable door 110 to shift positions or be displaced by a pressure or force applied to the movable door 110.

The security door jamb 104 may also be equipped with various electronic components, such as microphones, communication interfaces, processors etc. For example, the security door jamb 104 may be configured to notify a security service, emergency responder, or homeowner via the communication interface to the detection of a disturbance with respect to the sliding door 102. In some cases, the security door jamb 104 and/or the sliding door 102 or window that the security door jamb 104 is being used to secure may be at a location distanced from a power source, such as a wall outlet. Thus, in these cases, the security door jamb 104 may be equipped with an internal power source or supply. In some cases, the power source or supply may be rechargeable. However, in some instances, such as when the homeowner is on vacation, the power source or supply may be insufficient for the period of time associated with the continued use of the security door jamb 104. In these instances, the security door jamb 104 may be coupled to a portable power assembly 106 via a cable 116.

The power assembly 106 may include a backup power source or supply that may be configured to trickle charge the power source or supply of the security door jamb 104 to extend the overall life of the security door jamb 104. In some cases, the power assembly 106 may also include a solar power assembly to provide further extensions to the internal power supply and/or the power source or supply of the security door jamb 104.

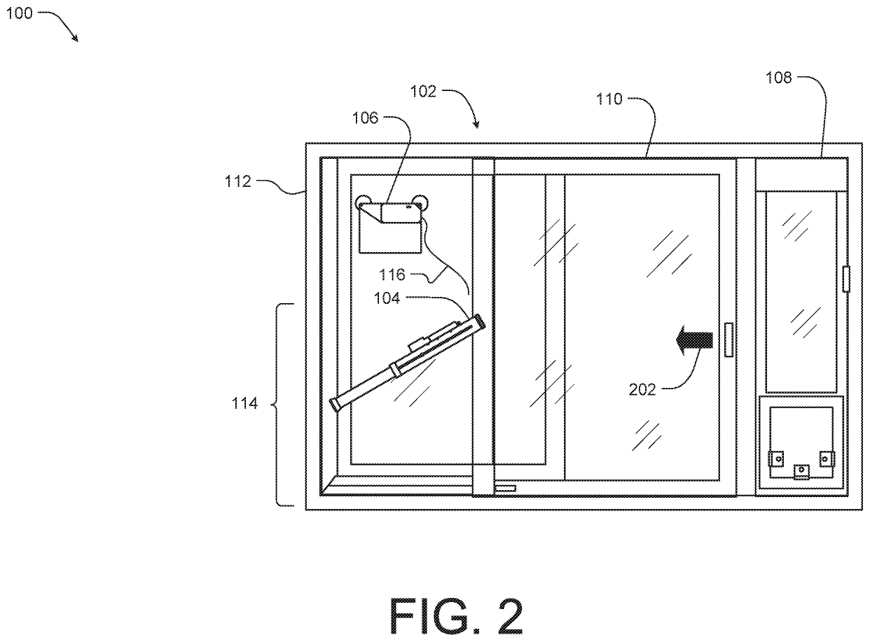

FIG. 2 illustrates the example environment 100 of FIG. 1 including a sliding door 102 with a security system, including a security door jamb 104 and a power assembly 106, installed during a home invasion according to some implementations. As discussed above, if a home invader opened the movable door 110 of the sliding door 102, as shown by 202, the security door jamb 104 would either first need to be displaced for the movable door 110 to shift positions or be displaced by a pressure or force applied to the movable door 110. In this example, the security door jamb 104 may be equipped with one or more measurement devices, such as IMUs, accelerometers, gyroscopes, barometric pressure sensors, magnetometers, or a combination thereof. Thus, the security door jamb 104 may be configured to detect the opening 202 of the movable door 110 based on the data collected by the measurement units of the security door jamb 104 exceeding one or more thresholds, such as by the fall incident illustrated in example 200.

The security door jamb 104 may also be equipped with various electronic components, such as microphones, speakers, image capture components, communication interfaces, processors etc. For example, the security door jamb 104 may be configured to notify a security service, emergency responder, or homeowner via the communication interface to the detection of the disturbance with respect to the sliding door 102 illustrated in the current example 200. In another example, the security door jamb 104 may activate the image capture components or emit audible alarm noises in response to detecting the disturbance.

In some cases, a home invader may attempt to disable or disconnect the power assembly 106 from the security door jamb 104. In other cases, the power assembly 106 may become disconnected from the security door jamb 104 due to the fall or disturbance of the security door jamb 104 within the sliding door 102, as shown by cable 116 disconnecting from security door jamb 104. In these cases, the power assembly 106 and/or the security door jamb 104 may emit the alarm, activate the image capture components, alert the homeowner, and/or notify the security service or emergency responders, as the disconnecting of the power supply 106 from the security door jamb 104 is an indication that the home may be being invaded. For instance, tampering may be likely if the security door jamb 104 has not received a recharge signal or power signal over a predefined period of time.

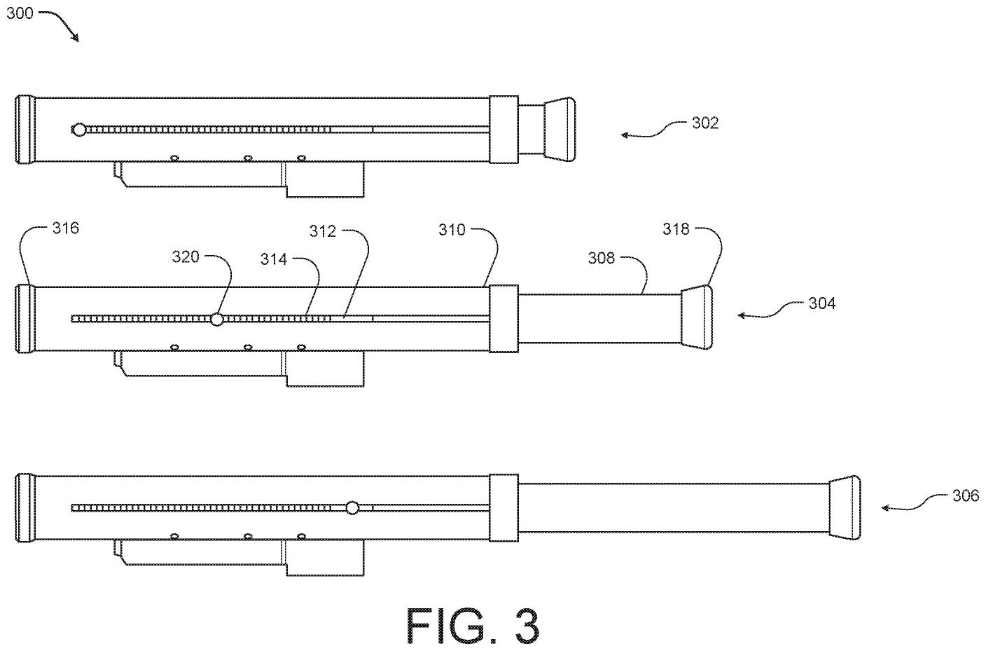

FIG. 3 illustrates an example top view of the security door jamb 300 in a contracted position 302, a partially extended position 304, and an extended position 306 according to some implementations. As discussed above, the security door jamb 300 is configured to have a variable size or length that may fit between a frame of a door and window and a sliding or movable portion of the door or window to thereby secure the open door or window. For instance, the security door jamb 300 may be configured or positioned vertically between a frame of a window and a movable portion of a window, such that a home invader would dislodge or disturb the security door jamb 300 when attempting to enter the home through the open window. The door jamb 300 may also be equipped with measurement units and/or processors configured to collect orientation data and determine from the orientation data that the security door jamb 300 has been disturbed. The security door jamb 300 may also include one or more communication interfaces for alerting security personal, emergency responders, or the homeowners to a disturbance. In some cases, the security door jamb 300 may also be configured to notify neighbors, such as by dialing or calling the phone numbers entered and stored on the security door jamb 300 by the homeowner.

In the current example, the security door jamb 300 includes an interior rod or member 308 configured to slide in and out of an exterior rod or member 310 to allow the security door jamb 300 to expand to as long as four foot in length in the extended position 306 or to contract to as small as one foot in length in the contracted position 302. For instance, the interior member 308 may be configured to slide or fit within the exterior member 310 when in the contracted position 302. For example, in the illustrated example, the security door jamb 300 may include a hex nut cap 312 coupled to a threaded rod 314 to allow a user to slide or contract the interior member 308 within the exterior member 310. For instance, a user may utilize the hex nut cap 312 or a locking mechanism 320 to slide the security door jamb 300 between a plurality of locked or set positions, thus allowing the security door jamb 300 to be secured at various sized openings.

The security door jamb 300 may also include an end cap 316 and a dampener 318 at opposing ends of the security door jamb 300. In some cases, the end cap 316 and/or the dampener 318 may be formed from a rubberized material, rubber, silicone material, polymer, or other material having a resistance to friction above a predetermined threshold. In one example, the threaded rod 314 may be permanently fused on one end to the end cap 316 and the other end of the threaded rod 314 may be threaded through or coupled to the hex nut cap 312. In some cases, the hex nut cap 312 may be fused to the interior member 308 such that when the hollow rod 308 is rotated around the central axis of the threaded rod 314, the interior member 308, the hex nut cap 312, and locking mechanism 320 move linearly along the central axis of the threaded rod 314.

In some cases, the exterior member 310 may be sized such that the interior member 308 may have clearance to travel within the internal cavity of the exterior member 310 to improve the effective range of linear positioning from approximately one foot to approximately four feet or from approximately six inches to approximately five feet. The interior member 308 may be sized such that its inner diameter may provide clearance for the threaded rod 314 while the assembly is moving linearly or contracting.

Once the security door jamb 300 is in the proper position for the application with respect to an opening, such as a sliding door, the threaded rod 314 may be locked in place by the locking mechanism 320 preventing further rotation or change in linear positioning of the security door jamb 300. Referring now to the hex cap 312, there may be in some examples a captive hex nut (not shown) embedded inside the hex nut cap 312. The hex nut cap 312 may be designed in such a way as to restrict the rotation of the hex nut 312 while the interior member 308 is being rotated to adjust the linear positioning of the security door jamb 300. This restriction allows the threaded rod 314 to travel linearly relative to the hex nut cap 312, which is permanently fused to the end of the exterior member 310.

In some examples, the exterior member 310 and/or the interior member 308 may be composed of a material with a rigidity of at least one gigapascal (GPa). For example, the exterior member 310 and/or the interior member 308 may be composed of aluminum, brass, bronze, copper, copper-based alloys, nickel-based alloys steel or zinc, among others. Additionally, exterior member 310 and/or the interior member 308 may be composed of plastic such as ABS, PC, PEI, PET, PEEK, PPA, and PPS along with many other plastic combinations and alloys. Additionally, exterior member 310 and/or the interior member 308 may be composed of any organic material, such as wood, that satisfies the rigidity requirements. For example, the exterior member 310 and/or the interior member 308 may be formed from steel, aluminum or a combination thereof.

In some embodiments, the hex nut cap 312 may be composed of a material with a rigidity of at least 500 MPa. For example, the hex nut cap 312 may be composed of aluminum, brass, bronze, copper, copper-based alloys, nickel-based alloys steel or zinc, among others. Additionally, hex nut cap 312 may be composed of plastic such as ABS, PC, PEI, PET, PEEK, PPA, and PPS along with many other plastic combinations and alloys. Additionally, hex nut cap 312 may be composed of any organic material, such as wood, that satisfies the rigidity requirements. In some embodiments, the threaded rod 314 may be composed of materials with a rigidity of at least 5 GPa. For example, the threaded rod 314 may also be composed of aluminum, brass, bronze, copper, copper-based alloys, nickel-based alloys steel or zinc, among others. In some embodiments, the end cap 316 shown in FIGS. 1 and 2 may be composed of a material with a rigidity of at least 500 MPa. For example, the end cap 16 may be composed of aluminum, brass, bronze, copper, copper-based alloys, nickel-based alloys steel or zinc, among others. Additionally, end cap 316 may be composed of plastic such as ABS, PC, PEI, PET, PEEK, PPA, and PPS along with many other plastic combinations and alloys. Additionally, hex end cap 316 may be composed of any organic material, such as wood, that satisfies the rigidity requirements. In some embodiments, the dampener 318 may be composed of a material with a shore hardness value under 90. For example, the dampener 318 may be composed of flexible plastics, rubbers, and urethanes.

In some examples, the locking mechanism 320 may be a screw, pin, latch or any other mechanism which prevents the threaded rod 314 from rotating and/or the exterior member 310 from moving linearly or locks the security door jamb 300 to a determined size based at least in part on the size of the opening the security door jamb 300 is securing.

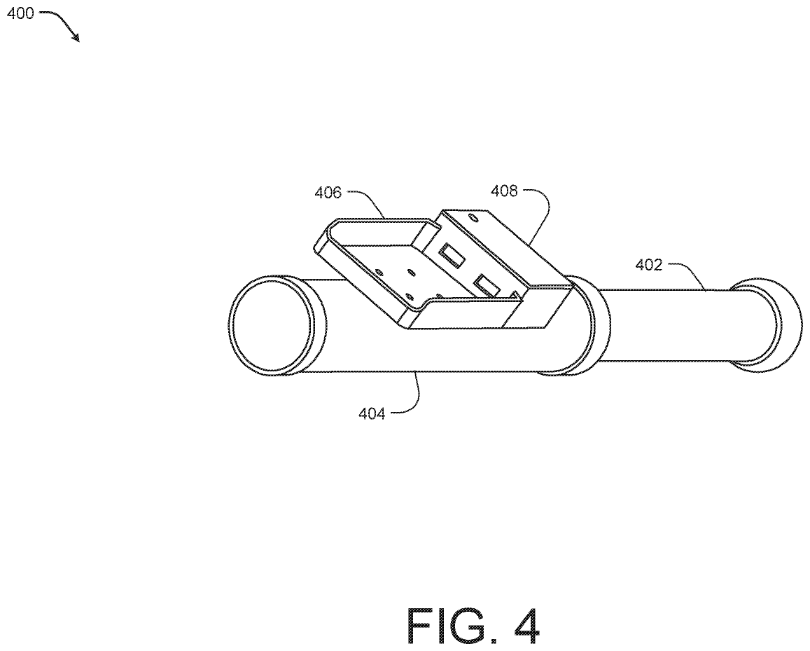

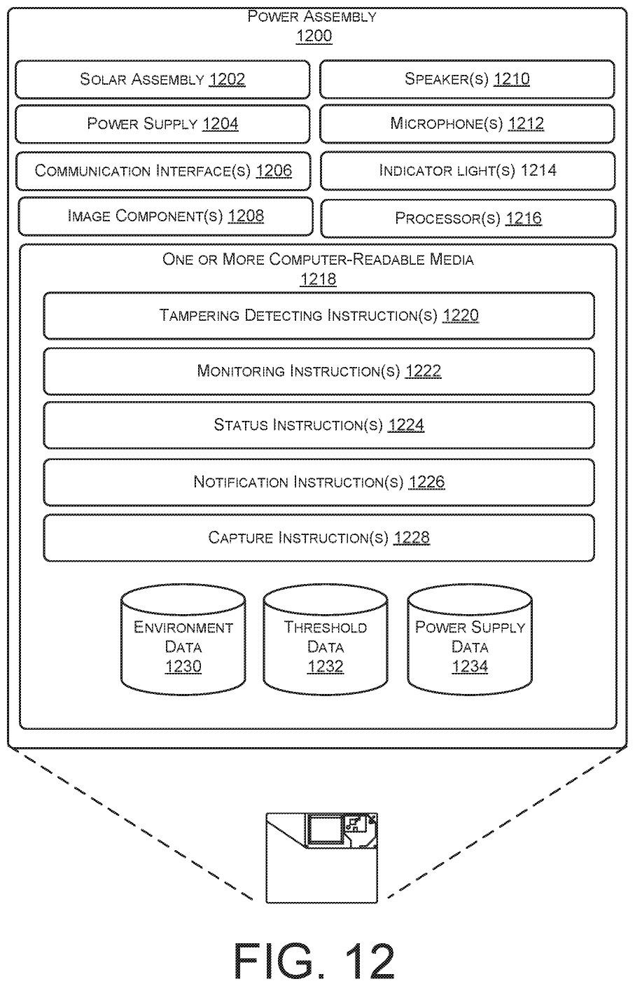

FIG. 4 illustrates an example perspective view of the security door jamb 400 according to some implementations. As discussed above the security door jamb 400 includes an interior member that is configured to retract within an exterior member 404 to allow the security door jamb 400 to adjust lengthwise to accommodate various sized openings. In some cases, the security door jamb 400 may be configured to include various electronic components, discussed in more detail below with respect to FIG. 12, such as one or more processors, one or more speakers, one or more microphones, one or more sensors or measurement devices, among others. In these cases, the security door jamb 400 may include a battery or battery mount 406 for receiving a rechargeable battery (not shown) positioned adjacent to a casing or housing 408 for containing the various electronic components. In this manner, a battery positioned within the battery mount 406 may be used as a power source for the various electronic components within the housing 408.

In some embodiments, the battery mount 406 may be designed to interface with any commonly available battery technology in order to power the various electronic components within the housing 408. Alternatively, in some examples, the various electronic components within the housing 408 may be powered through direct connection via electrical conductor to a permanent power source, in which case a battery would not be used.

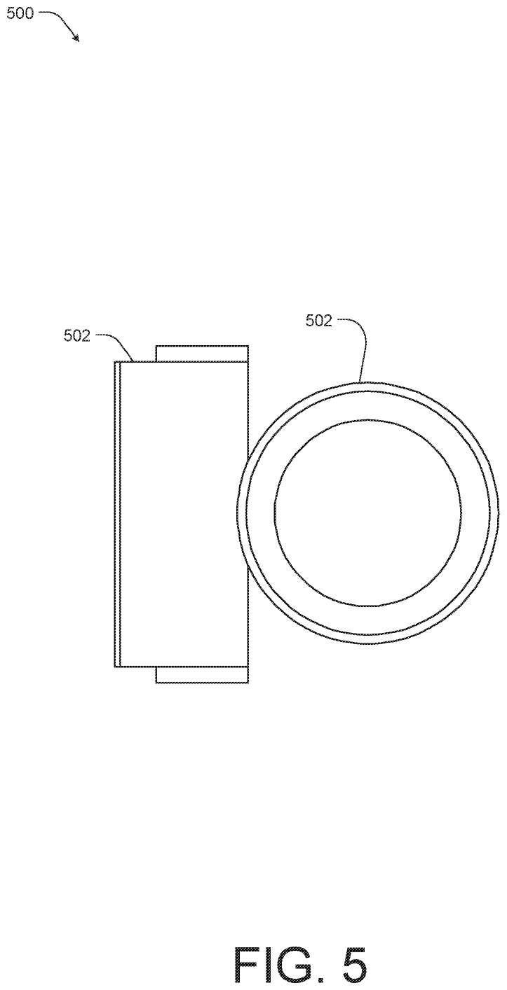

FIG. 5 illustrates an example side view of the security door jamb 500 according to some implementations. In the current example, the battery mount 502 is shown adjacent to the end cap 504. Thus, as illustrated, the battery mount 502 and/or the housing (not shown) may be configured at a position that does not obstruct the security door jamb 500 installation into a window or sliding door.

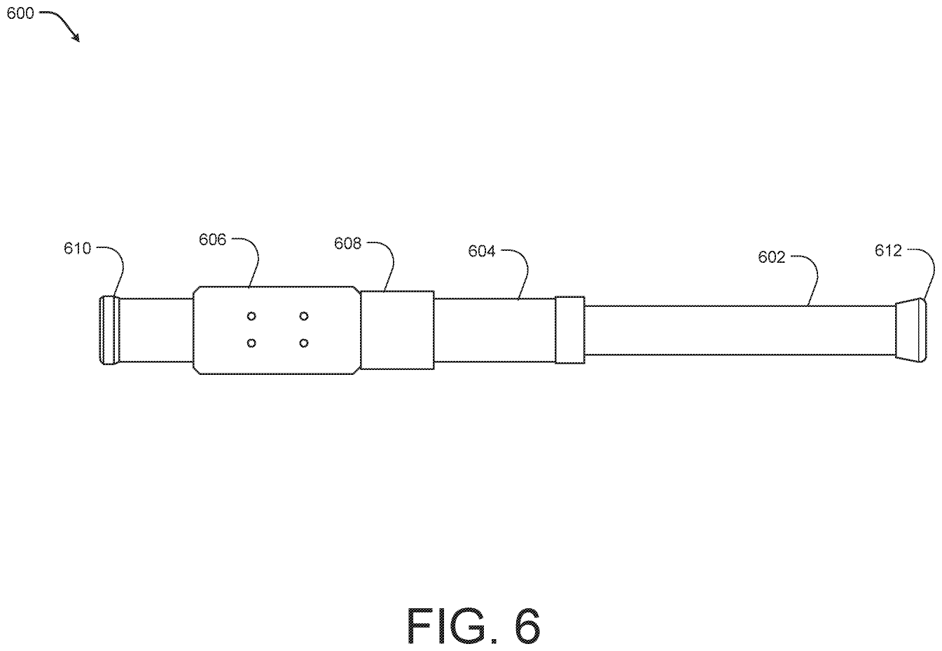

FIG. 6 illustrates another example top view of the security door jamb 600 according to some implementations. As discussed above, the security door jamb 600 is configured to have a variable size or length that may fit between a frame of a door and window and a sliding or movable portion of the door or window to thereby secure the open door or window. For instance, the security door jamb 600 may be configured or positioned vertically between a frame of a window and a movable portion of a window, such that a home invader would dislodge or disturb the security door jamb 600 when attempting to enter the home through the open window. The door jamb 600 may also be equipped with measurement units and/or processors configured to collect orientation data and determine from the orientation data that the security door jamb 600 has been disturbed. The security door jamb 600 may also include one or more communication interfaces for alerting security personal, emergency responders, or the homeowners to a disturbance.

In the current example, the security door jamb 600 may vary in length by including an interior member 602 configured to retract within an exterior member 604. The exterior member 604 may also include a battery mount 606 and a housing 608 for the internal electrical components associated with detecting the disturbance, contacting the homeowner and/or security personnel, as well as sounding an alarm or activating image components. The security door jamb 600 may also include end caps, such as end caps 610 and 612 having a coefficient of friction selected to prevent the security door jamb 600 from falling when placed off of the ground in a doorway or another opening.

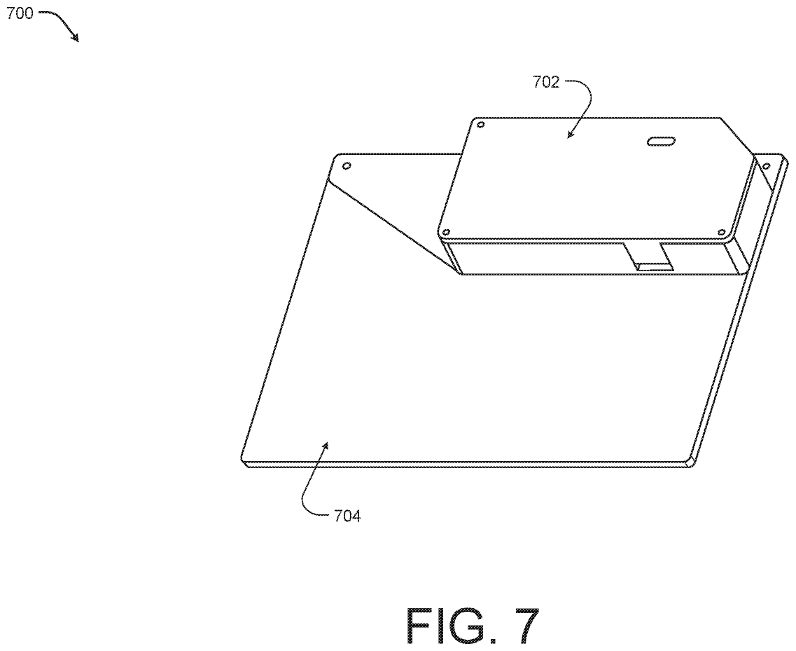

FIG. 7 illustrates an example back perspective view of the portable power assembly 700 according to some implementations. In the illustrated example, an electronics housing 702 is configured along the back side or non-collecting side of a solar panel 704. In some cases, the electronics housing 702 may be configured to include processing units, indicator lights, wireless communication interfaces, memory devices, etc.

In some cases, a security door jamb and/or the door or window that the security door jamb is being used to secure may be at a location distanced from a power source. Thus, in some cases, the security door jamb may be equipped with an internal power source or supply, as discussed above. In some cases, the power source or supply may be rechargeable. However, in some instances, such as when the homeowner is on vacation, the power source or supply may be insufficient for the period of time associated with the continued use of the security door jamb, such as when the door jamb is installed in a sliding door having a pet insert. In these instances, the security door jamb may be coupled to the portable power assembly 700.

The portable power assembly 700 may include a backup power source or supply secured within the housing 702 and rechargeable via the energy collected by the solar panel 704. For instance, the power assembly 700 may be configured to trickle charge the power source or supply of the security door jamb to extend the overall life of the security door jamb by draining the power supply within the housing 702. In other instances, a battery management circuit of the power assembly 700 or a shared circuit between the power assembly 700 and the door jamb may be configured such that the power signal or load is received or pulled directly from the solar panel 704 or array prior to draining the power supply in the power assembly. Thus, in these instances, the primary power source is the solar panel 704 or array and the power supply of the power assembly 700 may act as a backup when the supplied voltage from the solar panel 704 is below a predefined threshold, such as a load requirement associated with the security door jamb.

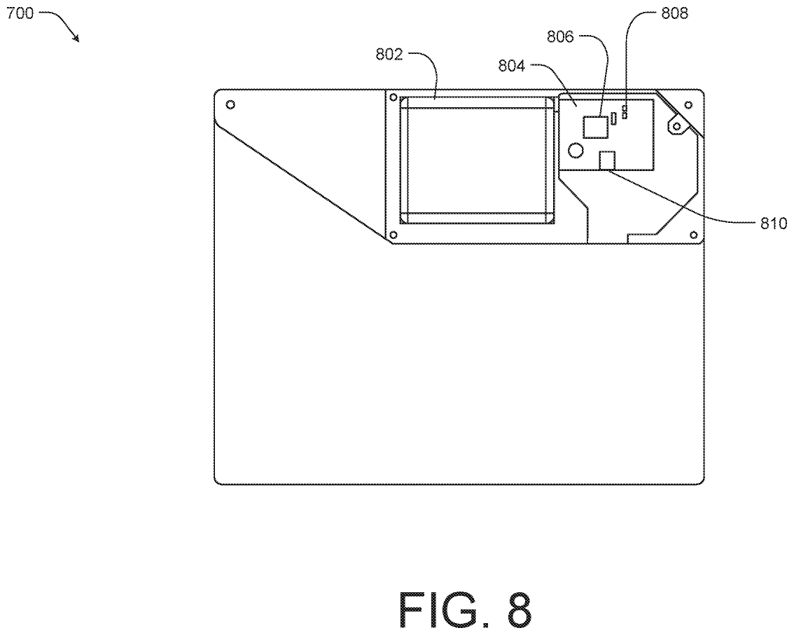

FIG. 8 illustrates an example top view of the portable power assembly 700 of FIG. 7 having the cover of the housing 702 removed according to some implementations. In the illustrated example, the portable power assembly may include a battery 802, circuit assembly 804, processing unit 806, indicator lights 808 and wireless communications hardware or interfaces 810. In some cases, the power assembly 700 may be equipped with one or more communication interfaces for providing power status data to a homeowner or other security service. In some cases, the power assembly 700 may be configured to alert the homeowner or a security personal when various issues or concerns with respect to the power assembly 700 occur. For instance, the power assembly may provide alerts to the homeowner or security service that the power level associated with the power source or supply of the power assembly has fallen below one or more predefined thresholds. In some cases, the power supply dropping below one or more of the predefined thresholds may indicate that the solar panel 704 is malfunctioning or blocked and that the system requires maintenance. Thus, the circuit 804 may be configured to detect the falling power supply and to alert the security service to send a maintenance repairman or employee to check on the power assembly by providing a notification via the communication interfaces 810, such as via a cellular, wired, or wireless network.

In some cases, the circuit 804 may be configured to detect if the power assembly 700 becomes decoupled from the security door jamb, and in response, to emit the alarm, alert the homeowner, and/or notify the security service or emergency responders via a speaker or the communication interfaces discussed above. For instance, the circuit 804 may monitor a power signal being delivered to the security door jamb and to emit the alarm, alert the homeowner, and/or notify the security service or emergency responders if the circuit detects a failure or cessation of the delivery of the power signal.

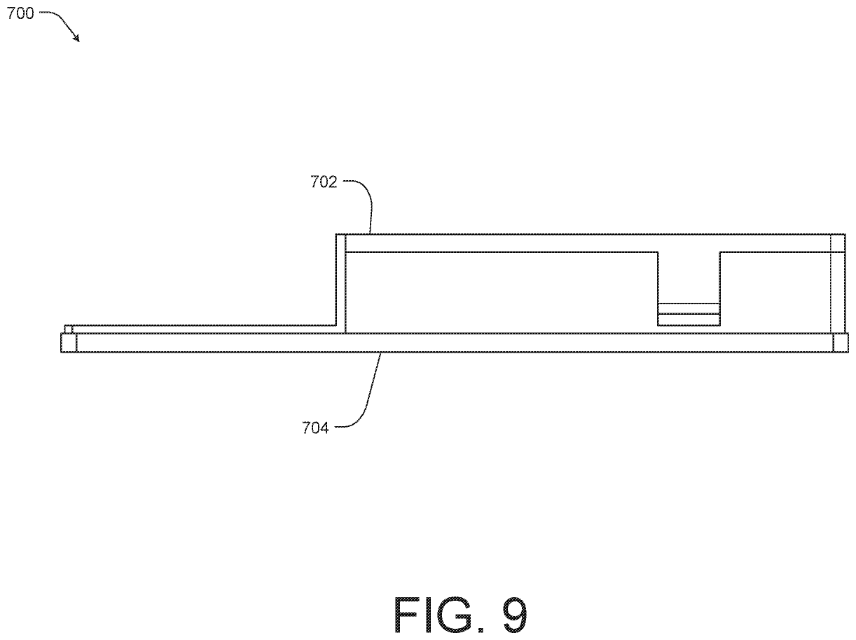

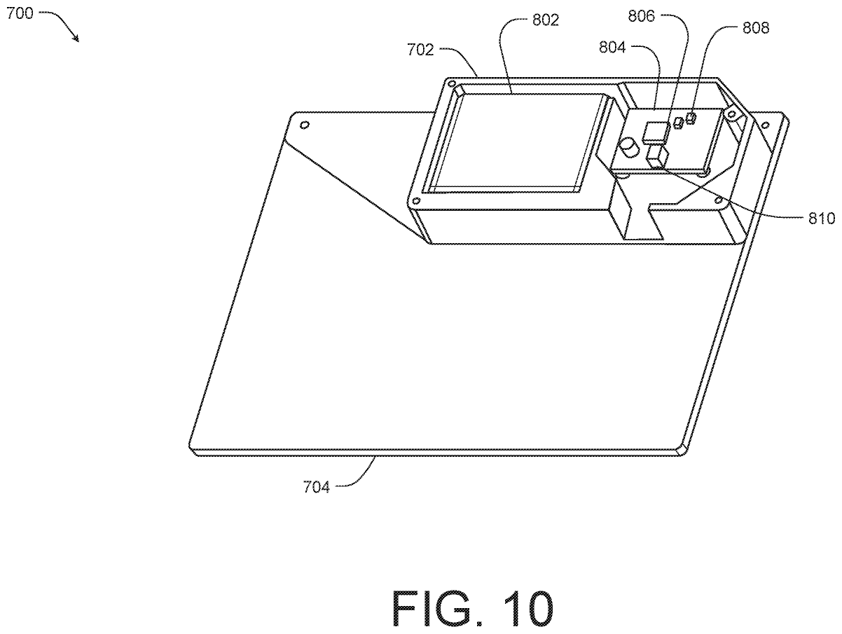

FIG. 9 illustrates an example side view of the portable power assembly 700 of FIG. 7 according to some implementations and FIG. 10 illustrates an example perspective view of the portable power assembly of FIG. 7 having the cover of the housing removed according to some implementations. As discussed above, the portable power assembly 700 may include an electronics housing 702 that is configured along the back side or non-collecting side of a solar panel 704. In some cases, the electronics housing 702 may be configured to include the battery 802, circuit assembly 804, processing unit 806, indicator lights 808 and wireless communications hardware or interfaces 810 as well as other components.

In some cases, a security door jamb and/or the door or window that the security door jamb is being used to secure may be at a location distanced from a power source. Thus, in some cases, the security door jamb may be equipped with an internal power source or supply, as discussed above. In some cases, the power source or supply may be rechargeable. However, in some instances, such as when the homeowner is on vacation, the power source or supply may be insufficient for the period of time associated with the continued use of the security door jamb, such as when the door jamb is installed in a sliding door having a pet insert. In these instances, the security door jamb may be coupled to the portable power assembly 700.

The portable power assembly 700 may include a backup power source or supply, such as the battery 802, secured within the housing 702 and rechargeable via the energy collected by the solar panel 704. For instance, the power assembly 700 may be configured to trickle charge the power source or supply of the security door jamb to extend the overall life of the security door jamb by draining the battery 802 within the housing 702. In other instances, a circuit 804 of the power assembly 700 or a shared circuit between the power assembly 700 and the door jamb may be configured such that the power signal or load is received or pulled directly from the solar panel 704 or array prior to draining the battery 802 in the power assembly. Thus, in these instances, the primary power source is the solar panel 704 or array and the battery 802 may act as a backup when the supplied voltage from the solar panel 704 is below a predefined threshold, such as a load requirement associated with the security door jamb.

In some cases, the power assembly 700 may be configured to alert the homeowner or security personnel in lieu of or in addition to the security door jamb when various issues or concerns with respect to the power assembly 700 occur. For instance, the power assembly 700 may provide alerts to the homeowner or security service that the power level associated with the battery 802 when the battery 802 has fallen below one or more predefined thresholds. In some cases, if the battery 802 drops below one or more of the predefined thresholds, the drop may indicate that the solar panel 704 is malfunctioning or blocked and that the power assembly 700 requires maintenance.

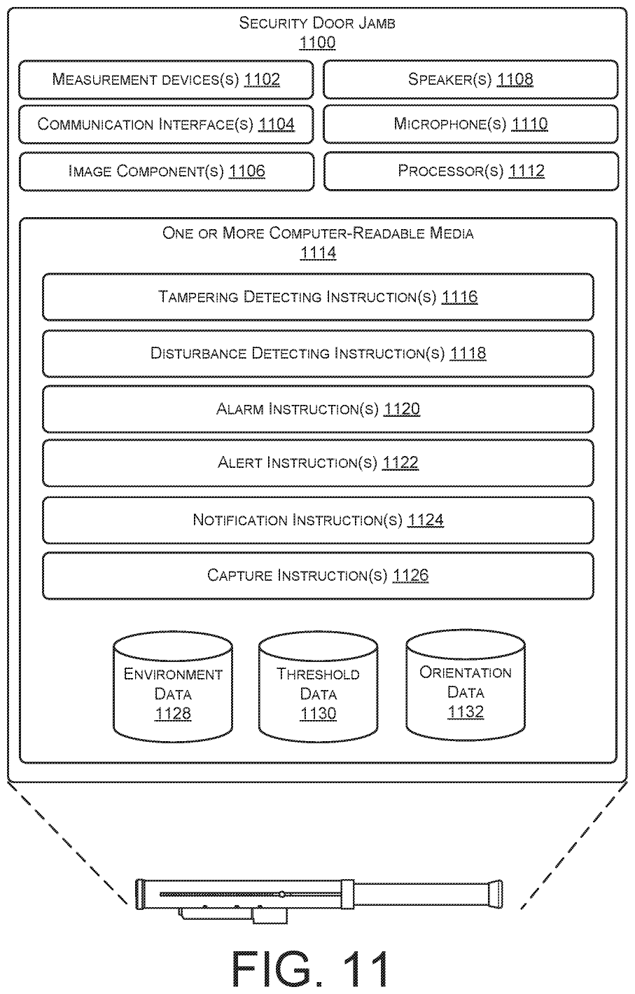

FIG. 11 illustrates example components of the security door jamb 1100 according to some implementations. In some example's, the security door jamb 1100 may be used to secure a sliding door or window in an open position against invasion. For instance, many pet owners configure a sliding door or window of the owner's home with an insert having a pet door or dog door to allow the owner's pets the ability to enter and exit the home without assistance from the pet owner. Unfortunately, when one of these inserts are installed in a sliding door or window, the sliding door or window remains in an open and unlocked position, as the insert is placed between the door and the door frame preventing the locking mechanism of the door or window from engaging. In these situations, the security door jamb 1100 may be configured with variable length to be sizable to fit between the gap created between the open door and the door frame caused by the pet door insert. For instance, the security door jamb 1100 may be equipped with a configurable locking screw mechanism that allows the user to increase or decrease the length of the security door jamb between four feet and one foot in length. In another instance, the length of the security door jamb may vary between two feet and one foot.

In some implementations, the security door jamb 1100 may be configured to be placed within an open sliding door or window, such that the security door jamb 1100 is located at a distance from the ground or other horizontal surface, such that the security door jamb 1100 may vibrate, drop, fall, or otherwise be disturbed in the event that an individual attempts to open the sliding door or window. In some cases, the security door jamb 1100 may be equipped with measurements devices or components to determine orientation data or position data of the of the security door jamb 1100. For instance, the security door jamb 1100 may be equipped with one or more measurement units 1102, such as internal measurement units (IMU), accelerometers, gyroscopes, barometric pressure sensors, magnetometers, or a combination thereof capable of capturing orientation data of the door jamb, such as acceleration data, momentum data, position data, etc. In one particular example, the measurement units 1102 may include three accelerometers placed orthogonal to each other, three rate gyroscopes placed orthogonal to each other, three magnetometers placed orthogonal to each other, and a barometric pressure sensor.

The security door jamb 1100 may also include one or more communication interfaces 1104, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 1104 may allow the security door jamb 1100 to send alerts and notification to homeowners, security personnel and/or emergency responders.

The security door jamb 1100 may also include image components 1106 for capturing visual data, such as images or frames, from a physical environment. For example, the image components 1106 may be positioned to capture multiple image or video data associated with the entryway or opening (e.g., the doorway or window). In these cases, the image components 1106 may capture images of the home invader or cause of the disturbance to the security door jamb 1100. In some cases, the image components 1106 operating with respect to the communication interfaces 1104 to allow the security door jamb 1100 to stream video content and/or image data to the homeowner, security personnel, and/or emergency responders.

The security door jamb 1100 may also be equipped with one or more speakers 1108 to output audio signals as sound into an environment and one or more microphones 1110 to capture sound from the environment and convert the sound into audio signals. The microphones 1110 may be a microphone array, a calibrated group of microphones, or multiple microphone arrays or calibrated groups. In some examples, microphones 1110 or speakers 1108 may be incorporated with an analog-to-digital converter or digital-to-analog converter to convert the sound from and into digital signals for processing. In general, the microphones 1110 may be configured to activate m response to the security door jamb 1100 detecting a disturbance. In some cases, the microphones 1110 may capture data that may be provided or sent via the one or more communication interfaces 1104 to devices associated with homeowners, security personnel, and/or emergency responders. In some examples, the speaker 1108 may be configured to output warning or alarm messages in response to the security door jamb 1100 detecting a disturbance. For example, the speakers 1108 may output messages to make the home invader away of the security message being taken including alerting the homeowners, security personnel, and/or emergency responders to the invaders presence in the home, for instance, to scare the potential home invader away.

The security door jamb 1100 may include one or more processors 1112, and computer-readable storage media 1114. The computer-readable storage media 1114 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1114 and configured to execute on the processors 1112. For example, tampering detection instructions 1116, disturbance detecting instructions 1118, alarm instructions 1120, notification instructions 1124, and capture instructions 1126. In some implementations, the computer-readable media 1114 may store data, such as environment data 1128, threshold data 1130, and orientation data 1132.

The tampering detection instructions 1116 may be configured to determine if an invader or other individual is attempting to disable the security door jamb 1100. For example, the tampering detection instructions 1116 may be configured to monitor a power signal or supply being drawn from a coupled power supply assembly and to determine that the security door jamb 1100 is being tampered with when the power signal falls below one or more of the thresholds (such as a power signal threshold) for more than a predetermined period of time.

The disturbance detecting instructions 1118 may be configured to receive the orientation data 1132 collected by the measurement units 1102 and to determine based on a change in momentum, angular velocity, orientation, or otherwise related to the position of the security door jamb 1100. In some cases, the disturbance detecting instructions 1118 may apply one or more thresholds 1130 to the orientation data 1132 collected by the measurement units 1102 before determining that the security door jamb 1100 is being disturbed in a manner indicative of a home invasion. For example, a pet traversing the pet door insert placed within the sliding door secured by the security door jamb 1100 may cause a slight vibration or other disturbance to the security door jamb 1100. However, someone opening the sliding door would dislodge the security door jamb 1100 causing a much larger change in momentum or other orientation data 1132 when compared with the pet bumping the door insert. Thus, the security door jamb 1100 may be configured to differentiate between types of disturbances using the threshold data 1130. In one example, the measurement units 1102 may include position sensors, such as a Global Position System (GPS), that may be configured to monitor the position of the security door jamb 1100 in addition to the measurement units 1102.

The alarm instructions 1120 may be configured to cause the speakers 1108 to emit an audible alarm in response to the disturbance detecting instructions 1118 detecting a disturbance of the security door jamb 1100. For example, the alarm instructions 1120 may allow the homeowner to record a customized message or utilize a preprogramed message. In some cases, the message may alert the invader to the fact that homeowner, security personnel, and/or emergency responders have been contacted. In other cases, the message may simply attempt to emit loud noises or alarm sounds to draw attention to the home invader and dissuade him/her from continuing the invasion.

The notification instructions 1124 may be configured to send via the one or more communication interfaces 1104 a notification or alert to the homeowner, security personnel, and/or emergency responders to cause the homeowner, security personnel, and/or emergency responders to become aware of the instance of the home invasion detected by the security door jamb 1100. In some cases, the notification or alert may also ask for a location of the homeowner to ensure that the homeowner is not within the home as the home is being invaded (such as to prevent more violent crimes that may occur in response to an incidental run in between the homeowner and the home invader). In one specific example, the security door jamb 1100 or a cloud-based resource and/or mobile device application associated with the security door jamb 1100 may be configured to gather the location of the homeowner and to report the location as well as the notification to the security personnel and/or emergency responders.

The capture instructions 1126 may be configured to capture data related to the environment (e.g., the environment data 1128). For example, the capture instructions 1126 may in response to receiving an indication of a disturbance activate the microphones 1110 and/or image components 1108. Once activated the microphones 1110 may capture audio data related to the home invasion and the image components 1108 may capture image data of the home invasions. In this manner, the security door jamb 1100 may assist security officials with identifying the home invader, for instance, during an investigation.

FIG. 12 illustrates example components of the portable power assembly 1200 according to some implementations. In some examples, a security door jamb (not shown) may be at a location distance from a power source and, in some instances, such as when the homeowner is on vacation, the power source or supply may be insufficient for the period of time associated with the continued use of the security door jamb. In these instances, the security door jamb may be coupled to the portable power assembly 1200.

The portable power assembly may include a backup power source or supply that may be configured to trickle charge the power source or supply of the security door jamb to extend the overall life of the security door jamb. In some cases, the portable power assembly may also include a solar power assembly to provide further extensions to the internal power supply and/or the power source or supply of the security door jamb. In some instances, the battery management circuit of the power assembly or a shared circuit between the power assembly and the door jamb may be configured such that the power signal or load is received or pulled directly from the solar panel or array prior to draining the power supply in the power assembly. Thus, the primary power source is the solar panel or array and the power supply of the power assembly may act as a backup when the supplied voltage from the solar panel or array is below a predefined threshold, such as a load requirement associated with the security door jamb.

The portable power assembly 1200 may be equipped with one or more solar assemblies 1202 for capturing energy from the light sources, such as the sun, and converting the energy into electricity. In some cases, the solar assembly 1202 may include one or more solar cells, modules, panels formed from photovoltaic cells or materials.

The solar assembly 1202 may be coupled to one or more power sources 1204 for storing the electricity collected by the one or more solar assemblies 1202. In other cases, the solar assembly 1202 may be configured to provide a power signal or the electricity to a coupled device, such as the security door jamb 1100 of FIG. 11.

The power assembly 1200 may also include one or more communication interfaces 1206, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 1206 may allow the power assembly 1200 to send alerts and notification to homeowners, security personnel and/or emergency responders in response to the power assembly 1200 becoming decoupled from a connected device, such as the security door jamb 1100 of FIG. 11.

The power assembly 1200 may also include image components 1208 for capturing visual data, such as images or frames, from a physical environment. For example, the image components 1208 may be positioned to capture multiple images or video data associated with the power assembly 1200 or coupled device. In these cases, the image components 1208 may capture images of an individual that contacts, touches, or attempts to disable the power assembly 1200. In some cases, the image components 1208 operating with respect to the communication interfaces 1206 allow the power assembly 1200 to stream video content and/or image data to a remote device or server.

The power assembly 1200 may also be equipped with one or more speakers 1210 to output audio signals as sound into an environment and one or more microphones 1212 to capture sound from the environment and convert the sound into audio signals. The microphones 1212 may be a microphone array, a calibrated group of microphones, or multiple microphone arrays or calibrated groups. In some cases, the microphones 1212 may capture data that may be provided or sent via the one or more communication interfaces 1206 to devices associated with homeowners, security personnel, and/or emergency responders. In some examples, the speaker 1210 may be configured to output warning, alarm, or status messages. For example, the speakers 1210 may output status messages related to the operations of the power assembly 1200 or the solar assemblies 1202.

The power assembly 1200 may also include indicator lights 1214 to provide status indications to maintenance personnel or homeowner. For example, the power assembly 1200 may be equipped with lights having various colors or states (e.g., flashing, steady, periodic, etc.) to notify an individual viewing the lights 1214 to the status of the power assembly 1200 or components of the power assembly 1200, such as the solar assemblies 1202 or the power supplies 1204.

The power assembly 1200 may include one or more processors 1216, and computer-readable storage media 1218. The computer-readable storage media 1218 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1218 and configured to execute on the processors 1216. For example, tampering detection instructions 1220, monitoring instructions 1222, status instructions 1124, notification instructions 1126, and capture instructions 1128. In some implementations, the computer-readable media 1218 may store data, such as environment data 1130, threshold data 1132, and power supply data 1134.

The tampering detection instructions 1220 may be configured to determine if an invader or other individual is attempting to disable the power assembly 1200. For example, the tampering detection instructions 1220 may be configured to monitor a power signal or supply being drawn from a coupled power supply assembly and to determine that the power assembly 1200 is being tampered with or disconnected from an associated device. For instance, the tampering detection instructions 1220 may determine tampering in response to detecting that the power draw on the solar assemblies 1202 or the power supply 1204 has fallen below a threshold 1232 for a predetermined period of time.

The monitoring instructions 1222 and the status instructions 1224 may be configured to monitor the status of the power delivery and the operations of the solar assemblies 1202 and the power supply 1204 as well as other internal components of the power assembly 1200 and alert maintenance personal, security personnel, homeowners, or emergency responders to the operations of the power assembly 1200. For example, the status instructions 1224 may cause the indicator lights 1214 to change or reflect particular statuses based at least in part on one or more operating thresholds or parameters and the data collected or determined by the monitoring instructions 1222.

The notification instructions 1226 may be configured to notify maintenance personnel and/or the homeowner m response to the monitoring instructions 1222 detecting a malfunction of one or more of the components of the power assembly 1200. In another example, the notification instructions 1226 may provide alerts or notifications to homeowners, security personnel, or emergency responses in response to the tampering instructions 1220 detecting tampering with respect to the power assembly 1200.

The capture instructions 1228 may be configured to capture data related to the environment (e.g., the environment data 1230). For example, the capture instructions 1228 may activate and deactivate the microphones 1212 and/or image components 1208. Once activated the microphones 1212 may capture audio data in the vicinity of the power assembly 1200 and the image components 1208 may capture image data in the vicinity of the power assembly 1200.

While in the above examples, the security door jamb and the power assembly 1200 are shown as two separate devices, in some examples, the security door jamb and the portable power assembly 1200 may be incorporated into a single device. For instance, the security door jamb may be configured to include a solar panel or assembly mounted on the exterior.

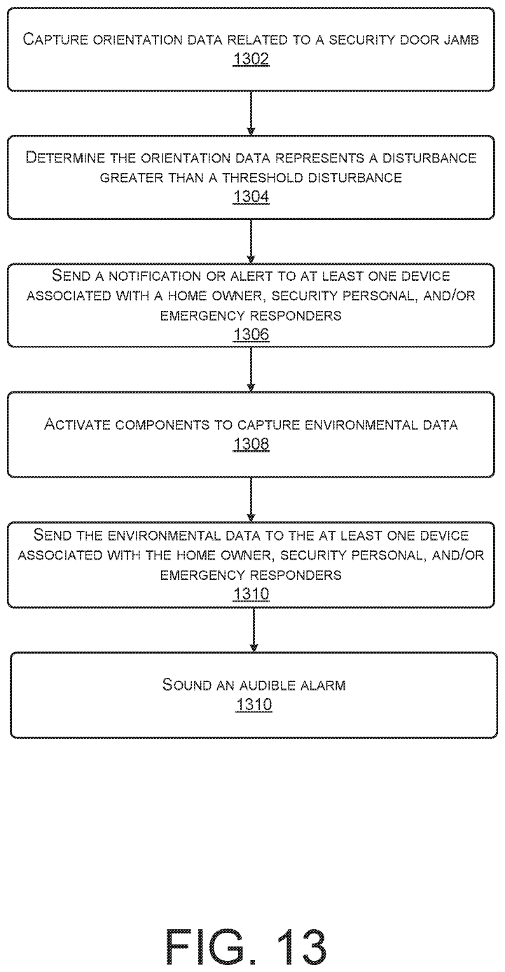

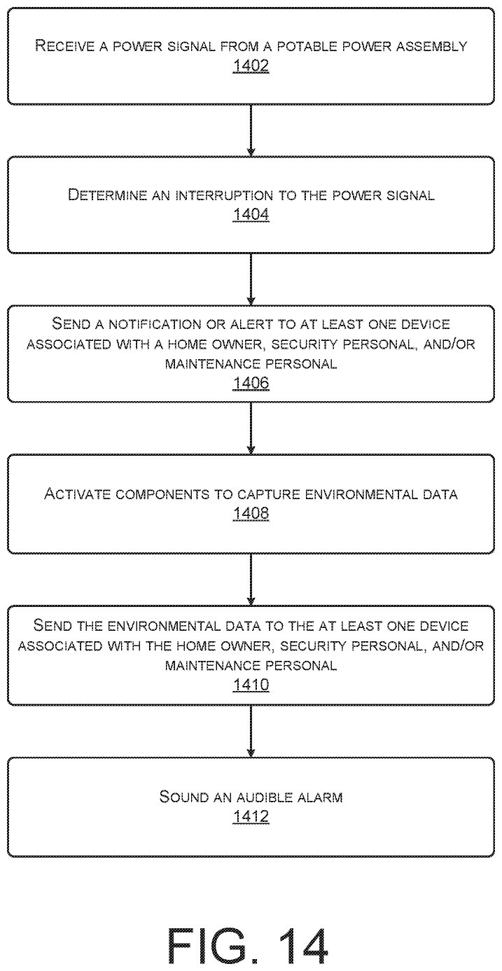

FIGS. 13 and 14 are flow diagrams illustrating example processes associated with securing an unlocked window or doorway according to some implementations. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 13 is an example flow diagram showing an illustrative process 1300 associated with detecting a home invasion according to some implementations. As discussed above, a security door jamb, discussed above, may be used to secure a sliding door or window in an open position against invasion. For example, the security door jamb may be configured with variable lengths to be sizable to fit between the gap created between an open door or window and the corresponding frame. For instance, the security door jamb may be equipped with a configurable locking screw mechanism that allows the user to increase or decrease the length.

At 1302, the security door jamb may capture orientation data associated with the position and/or movement of the security door jamb. For example, the security door jamb may be equipped with various measurement units or position sensors that can capture data related to changes in position, momentum, velocity, etc.

At 1304, the security door jamb may determine that the orientation data represents a disturbance greater than a threshold disturbance. For example, if the orientation data corresponds to a movement or change in position of more than a predicted amount, then it is likely that someone is attempting to open the door.

At 1306, the security door jamb may send a notification or alert to at least one device associated with a homeowner, security personnel, and/or emergency responder. For example, if the orientation data corresponds to a change in position of more than a predicted amount, then it is likely that someone is attempting to open the door and the security door jamb may notify the homeowner, security personnel, and/or emergency responder to assist with preventing the invasion and/or apprehend the invader.

At 1308, the security door jamb may activate components to capture environmental data associated with the door or window. For example, the security door jamb may include image capturing components and/or microphones to capture audio from the environment. In some cases, the security door jamb may store or stream the captured data to assist with preventing the invasion and/or apprehend the invader.

At 1310, the security door jamb may send the environmental data to the at least one device associated with the homeowner, security personnel, and/or emergency responder. For example, by providing the image data to the security personnel, the security personnel may put the policy or other agency on alert for a person identified within the image data.

At 1312, the security door jamb may sound an audible alarm For example, the alarm may sound to draw attention to the home invader and/or scare the home invader off.

FIG. 14 is an example flow diagram showing an illustrative process 1400 associated with detecting tampering with a portable power assembly connection to a security door jamb according to some implementations. In some examples, a security door jamb may be at a location distanced from a power source and, in some instances, such as when the homeowner is on vacation, the power source or supply may be insufficient for the period of time associated with the continued use of the security door jamb. In these instances, the security door jamb may be coupled to the portable power assembly and configured to determine if the power assembly has been disconnected or tampered with.

At 1402, the security door jamb may receive a power signal from a portable power assembly. For example, the portable power assembly may include one or more solar cells, modules, or panels that may be used to provide the power signal to the security door jamb.

At 1404, the security door jamb may determine an interruption to the power signal. For example, if the power signal fails to be received for a length of time exceeding a threshold, such as an hour, day, week, etc., then it is likely that the power assembly has been disconnected or is malfunctioning. In some cases, the power assembly may also be configured to detect the interruption in the delivery of the power signal or shared circuitry between the security door jamb and the power assembly may be used to detect the interruption.

At 1406, the security door jamb may send a notification or alter at least one device associated with a homeowner, security personnel, and/or maintenance personal. For example, if the power signal is not received for the length to time, then it is likely that someone has tampered with or disconnected the power assembly from the security door jamb or that the power assembly or security door jamb is malfunctioning. Thus, the security door jamb and/or the power assembly may send the notification to have an individual investigate the issue. In some cases, the individual notified may correspond to the voltage of the power signal and/or the number of times the power signal dropped below a threshold within a second length of time. For instance, if the power signal falls below the threshold but remains steady, it is more likely that the power assembly is malfunctioning than disconnected. Alternatively, if the power signal falls to zero for an extended period, then it is more likely the assembly has been tampered with or disconnected from the security door jamb.

At 1408, the security door jamb may activate components to capture environmental data associated with the door or window. For example, the security door jamb may include image capturing components and/or microphones to capture audio from the environment. In some cases, the security door jamb may store or stream the captured data to assist with determining the issue at hand (e.g., tampering or malfunction).

At 1410, the security door jamb may send the environmental data to the at least one device associated with the homeowner, security personnel, and/or maintenance personnel. For example, by providing the image data to the security personnel, the security personnel may determine if an officer should be dispatched.

At 1412, the security door jamb may sound an audible alarm For example, the alarm may sound to draw attention to the security door jamb in the case that the power assembly is being tampered with.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A portable power assembly comprising:
a solar assembly for capturing energy and converting the energy to power signal provided to a device reliably coupled to the portable power assembly;
a circuit to monitor the power signal being and determining that the power signal falls below a threshold; and
one or more communication interfaces to send a notification to a remote device in response to the power signal falling below the threshold.

17. The portable power assembly as recited in claim 16, wherein the circuit also determines if the fall in the power signal below the threshold is representative of tampering prior to the one or more communication interfaces sending the notification.

18. The portable power assembly as recited in claim 16, further comprising at least one indicator light.

19. The portable power assembly as recited in claim 16, further a speaker to output an audio signal as an audible alarm in response to the circuit determining that the power signal falls below a threshold.

20. The portable power assembly as recited in claim 16, further comprising:
one or more image components to capture an image data in response to the circuit determining that the power signal falls below a threshold; and
one or more microphones to capture an audio data in response to the circuit determining that the power signal falls below a threshold.
